(19) United States
(12) Patent Application Publication
(10) Pub. No.: US 2007/0005363 A1
(43) Pub. Date: Jan. 4, 2007

(54) Location aware multi-modal multi-lingual device

(75) Inventors: Silviu-Petru Cucerzan, Redmond, WA (US); David Joshua Kurlander, Seattle, WA (US); Michael J. Sinclair, Kirkland, WA (US); Yuan Kong, Kirkland, WA (US); Zhengyou Zhang, Bellevue, WA (US); David W. Williams, Woodinville, WA (US); Eric D. Brill, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/169,456

(22) Filed: Jun. 29, 2005

(51) Int. Cl. G10L 15/14

(52) U.S. Cl. 704/256

(57) ABSTRACT

Location-based technologies (e.g., global position system (GPS)) can be employed to facilitate providing multi-modal, multi-lingual location-based services. Identification of location can provide significant context as to identifying user state and intentions. Thus, location identification can facilitate providing/augmenting data and services (e.g., location-aware based suggestions, truncating contact lists based upon location, location-based reminders as a user approaches a predetermined location, truncating pre-loaded tasks, suggesting routes to accomplish pre-loaded tasks in a PIM). Still other aspects can augment GPS location identification with a compass, accelerometer, azimuth control, cellular triangulation, SPOT services of telephone, etc. Effectively, these alternative aspects can facilitate determination of a target location by detecting movement and direction of a user and/or portable device.

### BACKGROUND

Both enterprises and individuals are increasingly interested in using handheld devices. Most modem handheld devices are equipped with multiple sensors (e.g., microphone, wireless transmitter, global positioning system (GPS) engine, camera, stylus, etc.). However, there are no applications available that make full use of multiple sensors. In other words, multi-sensory technologies that make handheld devices a multi-modal, multi-lingual mobile assistant are not available.

Today, cellular telephones running on state-of-the-art operating systems have increased computing power in hardware and increased features in software in relation to earlier technologies. For instance, cellular telephones are often equipped with built-in digital image capture devices (e.g., cameras) and microphones together with computing functionalities of personal digital assistants (PDAs). Since these devices combine the functionality of cellular telephones with the functionality of PDAs, they are commonly referred to as “smartphones.” The hardware and software features available in these smartphones and similar technologically capable devices provide developers the capability and flexibility to build applications through a versatile platform. The increasing market penetration of these portable devices (e.g., PDAs) inspires programmers to build applications, Internet browsers, etc. for these smartphones.

The Internet continues to make available ever-increasing amounts of information which can be stored in databases and accessed therefrom. Additionally, with the proliferation of portable terminals (e.g., notebook computers, cellular telephones, PDAs, smartphones and other similar communications devices), users are becoming more mobile, and hence, trackable with respect to buying habits and locations that they tend to frequent. For example, many devices are being designed with a geographic location tracking technology such as GPS for reasons of safety, finding travel destinations, etc. Thus, it now becomes possible to determine the location of the user.

Location identification systems are used in many aspects of everyday life. By way of example, it has become increasingly more common for GPS to be integrated into automobiles to assist in navigation. Generally, a GPS system can, by triangulation of signals from three satellites, pinpoint a current location virtually anywhere on earth to within a few meters.

Knowledge of where the user has traveled, currently is, and is heading in an urban canyon, which includes structures such as multi-story buildings (principally, and whether the user is inside or outside of the building), but also include trees, hills, and tunnels (generally), can be of value to the user and to companies that seek to benefit economically by knowledge of the user location by providing location-based data and services to the user.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The invention disclosed and claimed herein, in one aspect thereof, comprises a system that facilitates multi-modal, multilingual location-based data and/or services. More particularly, aspects can employ a global position system (GPS) that identifies a current location of a user and/or portable device. Additionally, the system can maintain a log of locations with respect to the portable device and/or user. This log can be employed by an artificial intelligence (AI) and/or rules-based logic to infer a destination location. Accordingly, location-based data and/or services can be generated with respect to the current or inferred location.

A multi-language component can be provided that facilitates comprehendible communication. For example, the multi-language component can translate text and/or voice communication of the location-based data and services into a language comprehendible by a user or recipient. As well, the multi-language component can be employed to translate location-based data and/or services into a language (or dialect) that corresponds to the current (or destination) location. Moreover, aspects employ the multi-language component to translate any desired communication into any desired language and/or dialect.

The invention can employ a local and/or remote store to identify and render location-based data and/or services. For example, a local personal information manager (PIM) can be employed whereby contacts and calendar entries can be filtered and/or sorted based upon a location. As well, remote sources (e.g., remote server, Internet) can be employed to identify location-based information thereafter, rendering the identified information to a user, application, etc.

Location-based technologies (e.g., GPS, wireless, etc.) can be employed to facilitate providing multi-modal, multi-lingual location-based services. Identification of location can provide significant context as to identifying user state and intentions. Thus, location identification can facilitate providing/augmenting data and services (e.g., location-aware based suggestions, truncating contact lists based upon location, location-based reminders such as pick up dry cleaning as a user approaches a location of the cleaners).

Still other aspects can augment GPS location identification with a compass, accelerometer, azimuth control, cellular triangulation, etc. Effectively, these alternative aspects can facilitate determination of a target location by detecting movement and direction of a user and/or portable device. For example, aspects can employ GPS or other suitable technology to determine a current location of a device. Additionally, motion and direction sensor technologies can be employed to determine a relevant movement of the device. Accordingly, the aspect can infer and/or calculate a probable target location and time corresponding therewith. As a result, location-based data and services can be provided with respect to a current and/or target location.

In yet another aspect thereof, an AI component is provided that employs a probabilistic and/or statistical-based analysis to prognose or infer an action that a user desires to be automatically performed. The AI reasoning and/or learning logic can be provided to facilitate inferring and/or predicting a location of a user and/or device. Rules-based logic can also be provided in addition to or in place of the AI component. The rules-based logic component can facilitate automating functionality in accordance with a predefined or preprogrammed rule.

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a system that facilitates providing multi-lingual location-based functionality in accordance with an aspect of the invention.

FIG. 2 illustrates an exemplary flow chart of procedures that facilitate providing multi-lingual location-based functionality in accordance with an aspect of the invention.

FIG. 3 illustrates a block diagram of a portable device having a location detection system and a multi-language component in accordance with an aspect of the invention.

FIG. 4 illustrates a portable device that employs a global position system (GPS) and a movement detector to identify location-based data and services in accordance with an aspect of the invention.

FIG. 5 illustrates a portable device that includes a query component and a filter component that facilitates identifying location-based data and services in accordance with an aspect of the invention.

FIG. 6 illustrates a multi-modal, multi-lingual portable device that facilitates rendering multiple location-based data and service components in accordance with an aspect of the invention.

FIG. 7 is a schematic block diagram of a portable handheld device according to one aspect of the subject invention.

FIG. 8 illustrates an architecture of a portable handheld device including an artificial intelligence-based component that can automate functionality in accordance with an aspect of the invention.

FIG. 9 illustrates an architecture of a portable handheld device including a rules-based logic component that can automate functionality in accordance with an aspect of the invention.

FIG. 10 illustrates a block diagram of a computer operable to execute the disclosed architecture.

FIG. 11 illustrates a schematic block diagram of an exemplary computing environment in accordance with the subject invention.

### DETAILED DESCRIPTION

The invention is now described with reference to the drawings, wherein like reference numerals are used to refer to like elements throughout. In the following description, for purposes of explanation, numerous specific details are set forth in order to provide a thorough understanding of the subject invention. It may be evident, however, that the invention can be practiced without these specific details. In other instances, well-known structures and devices are shown in block diagram form in order to facilitate describing the invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the terms to “infer” and “inference” refer generally to the process of reasoning about or inferring states of the system, environment, and/or user from a set of observations as captured via events and/or data. Inference can be employed to identify a specific context or action, or can generate a probability distribution over states, for example. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

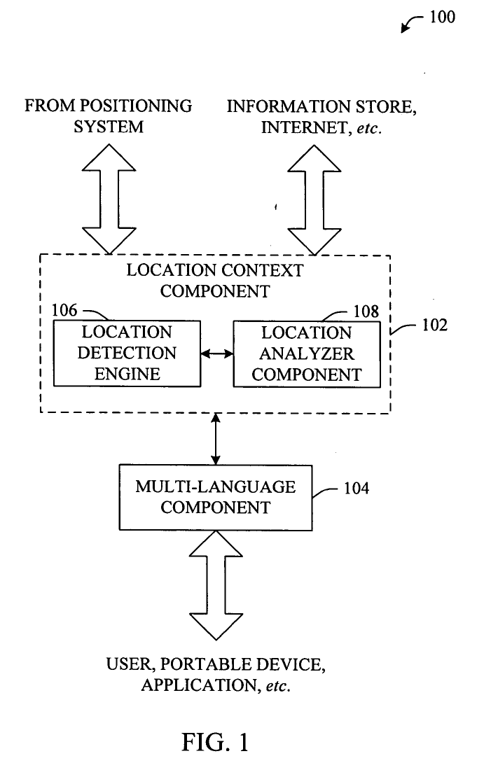

Referring initially to the drawings, FIG. 1 illustrates a multi-lingual system 100 having location identification functionality in accordance with an aspect of the invention. The multi-lingual system 100 of FIG. 1 can affect identification and/or generation of location-based data and services. Generally, system 100 can include a location context component 102 and a multi-language component 104. These components and their corresponding functionality are described in greater detail below.

The location context component 102 can facilitate identifying and providing content that corresponds to a location of a portable device. In accordance therewith, the location context component 102 can facilitate identifying a location of a device and thereafter can identify data and/or services that correspond to the location. In one aspect, the location context component 102 can include a location detection engine 106 and a location analyzer component 108.

As illustrated in FIG. 1, the location detection engine 106 can interface with a positioning system (e.g., global position system (GPS)) to determine a current location of a device. Once the location is determined, the location analyzer component 108 can facilitate identification and/or generation of location-based content. Additionally, the multi-language component 104 can facilitate formatting the content (e.g., data, service) into a language comprehendible to a user or group of users and/or recipients.

By way of example, in accordance with an aspect, suppose that a user intends to purchase a headset. Further, suppose that the user receives a catalog which has a set of headset collections available from a particular store. In accordance with the novel functionality described herein, the user can employ a suitably equipped portable device to capture an image of the catalog page that illustrates the desired product. As well, voice recognition functionality can be employed to correct or augment interpretation or recognition of the image. In one example, the catalog listing contains both telephone number and address information of the store.

Once the image is scanned and analyzed, the user can instruct the device to “call the store.” Thus, the telephone communication can be automatically established. In the event that the callee does not speak the same language as the caller (e.g., user), the device can determine a native dialect either through location detection or telephone number analysis. In other words, the device can employ location detection techniques to determine a current location of the telephone thereby inferring the native spoken language. Accordingly, the multi-lingual functionality of the device can be employed to translate incoming and outgoing speech signals thereby enabling comprehendible communication.

Continuing with the example, the user can inquire to the receptionist when the store will close. Thus, a determination can be made if time permits to visit the store. This determination can be made by automatically querying calendar appointments with respect to the current time and distance to the store location. It will be appreciated that a distance to the store from the device location can be automatically calculated using satellite location detection, cellular triangulation or the like.

Upon an affirmative determination that time exists to visit the store, the novel functionality can automatically access directions to the store. Since the device can be wirelessly-connected to the Internet, the user can instruct (e.g., audibly) the device to contact a service provider thereby generating specific directions to the store. Again, the satellite positioning system can facilitate identification of the reference (e.g., current) location. This current location can be employed together with the target location (e.g., store address) in order to establish directions to the store.

With continued reference to the example, while in the store, the user sees a product called “WITTY Wireless Stereo Headset”. In response thereto, the user scans (or captures an image of) the product name and reads it at the same time in order to get accurate recognition. Again, the device, through a suitable wireless connection, can generate product reviews from the Internet or other network/server. Additionally, in accordance with the location detection system, the device can notify the user of nearby locations to purchase the same, or similar, product at a better price. It is to be understood that this scenario is provided to detail some of the novel functionalities described herein. It will be appreciated that other multi-modal, multi-lingual aspects exist and are to be included in the scope of this specification as well as the claims appended hereto.

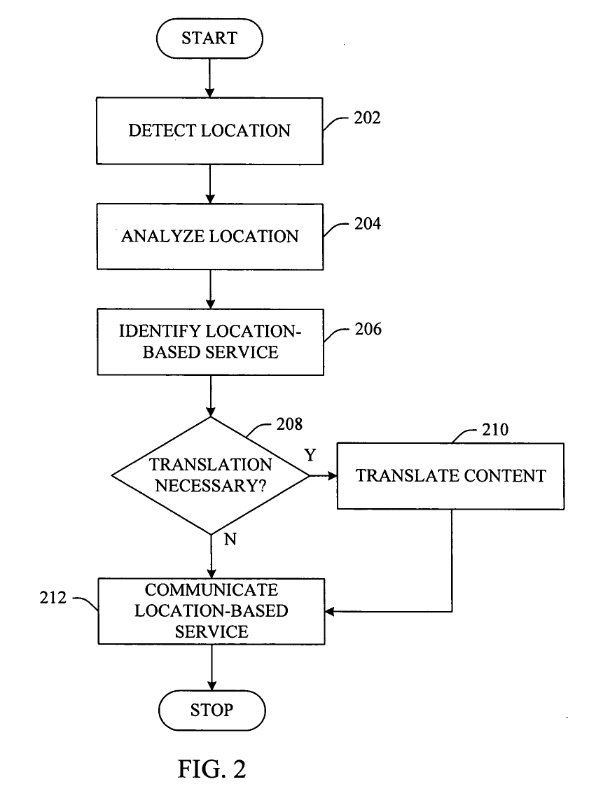

FIG. 2 illustrates a procedure flow of providing location-based information and/or services in accordance with an aspect of the invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the invention.

At 202, a location of a user and/or portable device can be detected. It is to be appreciated that any suitable method of identifying the location can be employed in accordance with the invention. By way of example, but not limitation, the location can be detected using methods such as GPS and cellular triangulation. It is to be appreciated that other aspects can be employed to additionally determine if the user and/or device is in motion. For example, services such as accelerometers, compasses, azimuth controls, and SPOT services can be employed to augment the location.

Once the location is determined, at 204, it can be analyzed with respect to an information store, Internet content, personal information manager (PIM) or the like. Accordingly, a location-based service (or data) can be identified at 206. At 208, a determination is made if, based upon user identity, inference, historical and/or statistical analysis, etc., translation is necessary. If, at 208, a determination is made that that translation is necessary, the content can be translated into an appropriate language and/or dialect of a user (or group of users). As described above, location detection can be employed to determine an appropriate language for which to translate.

On the other hand, if at 208 a determination is made that the identified service and/or data is formatted in an appropriate language and/or dialect corresponding to the instant user, the identified location-based service can be communicated to the user in lieu of re-formatting (e.g., translation). It is to be appreciated that this communication can occur in either an audible (e.g., spoken) or textual manner.

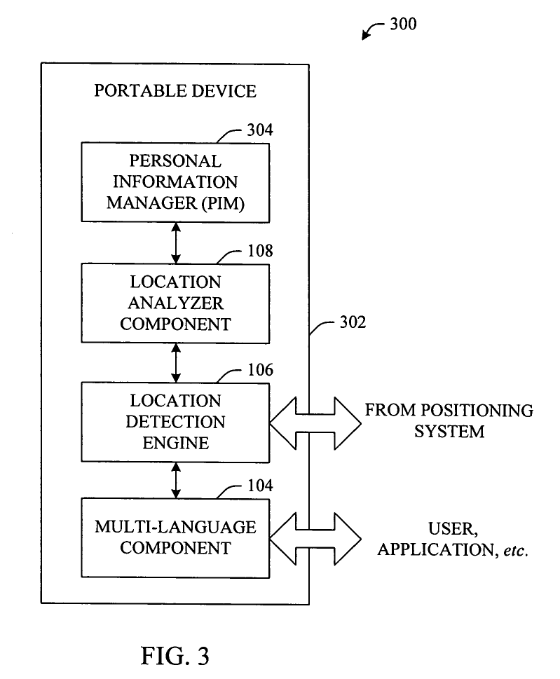

Referring now to FIG. 3, a system 300 that facilitates providing a user with location-based information is illustrated. Generally, the system 300 can include a portable device 302 capable of communicating with a location identification system (e.g., GPS) as shown. As illustrated, portable device 302 can include a multi-language component 104, a location detection engine 106, a location analyzer component 108 and a PIM component 304.

In operation, the location detection engine 106 can communicate with a positioning system to determine a location of the portable device 302. Once determined, the location analyzer component 108 can communicate with the PIM component 304 to obtain location-based information. For example, location analyzer component 108 can query and/or filter data of the PIM component 304 based upon the identified location. In one specific example, contact lists maintained within the PIM component 304 can be truncated or sorted based upon the location or distance from the determined location. In other words, the analyzer component 108 can truncate and/or sort a contact list based upon a distance relative to/from the current location. It will be appreciated that this data manipulation can be based upon any predefined criteria (e.g., rule) and/or artificial intelligence (AI) inference based analysis.

As stated supra, many modem handheld devices (e.g., cellular telephones, smartphones, pocket computers, personal data assistants (PDAs)) are equipped with multiple sensors. For example, it is common for a portable device to include a microphone, wireless transmitter, GPS, image capture device (e.g., camera, scanner), stylus, etc. In one aspect, because the invention employs a multi-language component 104, the functionality described herein can be particularly useful to international travelers to assist in communication in view of potential language barriers. For example, foreign travelers can employ the device 302 for understanding foreign signs and restaurant menus as well as for asking non-English speakers for directions using English. It is to be appreciated that the invention can be employed to communicate using any native or base language and/or dialect.

Additionally, as described above, the invention can be employed to regionally organize and/or truncate PIM data (or other data) based upon a location. Other aspects exist whereby the invention can infer a target location thus PIM data can be organized and/or truncated accordingly. Effectively, the invention can provide intelligent assistance to a user by leveraging redundancy and complimentarily of multi-modal information. Therefore, it can be possible to produce significantly better results than if one single modality is used.

The following scenarios are provided merely to add context to the invention and are not intended to limit the invention in any way. In other words, the scenarios included herein are provided to illustrate exemplary situations with regard to the novel functionality of the invention. As such, the scope of this disclosure and claims appended hereto are not to be limited by these exemplary scenarios.

In a first scenario, suppose a user is on a trip to Beijing from his native United States of America. Upon arriving at Beijing Airport, the user recognizes that all signs are in the native language of Beijing, Chinese. He cannot ask his fellow travelers to translate the signs because they do not speak English. Therefore, he takes out his portable device and snaps a photo of the signs with the built-in camera. Based upon GPS information, the portable device can identify that he is in China. Accordingly, the device can immediately translate the Chinese signs into English. Thus, he is able to locate the Customer Services and Baggage Claim areas without any difficulty even though he does not speak the Chinese language.

In addition to this scenario, it is to be appreciated that the location detection engine 106 together with the location analyzer component 108 can be employed to determine a location and regional dialect. The multi-language (e.g., multi-lingual) component can be employed to convert or translate the information captured in a foreign dialect into a comprehendible dialect.

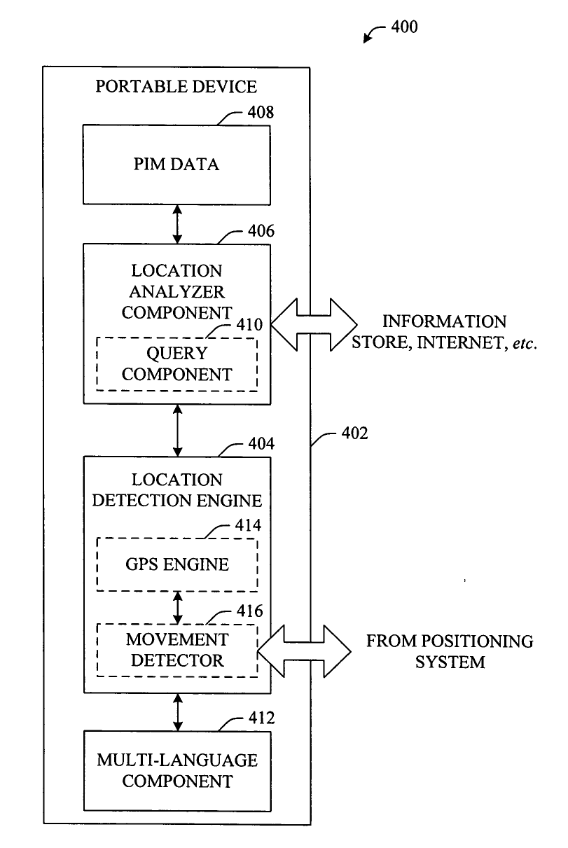

Referring now to FIG. 4, an alternative system 400 is shown. Generally, system 400 can include a portable device 402 capable of communicating with a position location system (e.g., GPS). Generally, portable device 402 can include a location detection engine 404 and a location analyzer component 406. The location detection engine 404 is capable of communicating with a position detection system in order to determine a physical location of the portable device 402.

The location analyzer component 406 can employ the determined location to generate location-based data and/or services. In one example, the analyzer component 406 can employ the determined location to filter PIM data 408 thus providing location-based data. By way of example, the location analyzer component 406 can employ a query component 410 to search PIM data 408 based at least in part upon the determined location. Accordingly, contact lists can be truncated and/or sorted based upon the location.

As well, location-based suggestions and reminders can be generated from a query of calendar entries and appointments based at least in part upon the location. For instance, upon knowing a specific current location, the analyzer component 408 can query the calendar appointments in the PIM data 408 thus suggesting an action (e.g., detour to drycleaners, stop at grocery store) based at least in part upon relative location and distance to a target location (e.g., drycleaner, grocery store). It is to be appreciated that these scenarios are merely exemplary and are not intended to limit the novel functionality of analyzing PIM data (or other available data) in relation to a location to generate location-based data, suggestions, reminders, actions and/or services.

Moreover, as illustrated, the location analyzer component 406 can access a remote information store and/or network source (e.g., Internet) to produce location-based services. For example, the location analyzer component 406 can employ the location generated via the location detection engine 404 to access information and/or services via the Internet. In one example, driving directions can be obtained from the detected location to a target location identified in PIM data. In another example, weather forecasts can be obtained based upon the detected location. In still another example, fueling stations can be identified with respect to the instant location whereby driving directions could then be generated. Essentially, any location-based information can be obtained and communicated via portable device 402.

It is to be appreciated that a voice or speech recognition engine (not shown) can be employed in conjunction with the determined location to instruct the location analyzer component 406 to generate location-based data and/or services. For example, a user can verbally instruct the device 402 to “generate directions to 123 Main Street.” Accordingly, the location analyzer component 406 can facilitate generation of directions from a current location of the device 402 to the target location, 123 Main Street. In addition, the location analyzer component can determine one or more intermediate locations of interest and add them to the destinations for which it computes location-based data and services.

Further, the location analyzer component can compute services for a route (and even optimize the route), e.g., not only for one destination, especially when the user provides the final destination. It is to be understood that audio commands can be employed to initiate and/or supplement generation of location-based data and/or services. A multi-language component 412 can be employed to enable a recognition and conversion of multiple languages.

With continued reference to FIG. 4, location detection engine 404 can generally include a GPS engine 414 and a movement detector 416. The GPS engine can be employed to generate a location using an intermediate circular orbit satellite constellation of satellites. The GPS engine 414 can receive signals from the satellites and thereafter determine a precise location of the device 402.

Additionally, the location detection engine 404 can include a movement detector 416 which can augment the location determined by the location detection engine 404 (e.g., GPS 414). In one example, an accelerometer can be employed to determine a movement of the device 402. As well, an azimuth control can be employed as a movement detector 416. In this example, an azimuth control can determine a horizontal direction of motion of device 402. Other examples of movement detectors 416 can include, but are not limited to include, compasses, cellular triangulation and SPOT services that facilitate determining a motion detection of the portable device 402. These additional movement detection techniques can augment the location detection engine system 404 (e.g., GPS 414) in order to determine the location (when GPS signals or other location-identification signals are temporary not available—e.g., inside a building) and to provide additional information to the location analyzer component 406 which can be employed to determine location-based data and/or services. For example, when a user is in a shopping area, on foot or in a car, the user can be presented with service options and possible routes through the area to access the services presented.

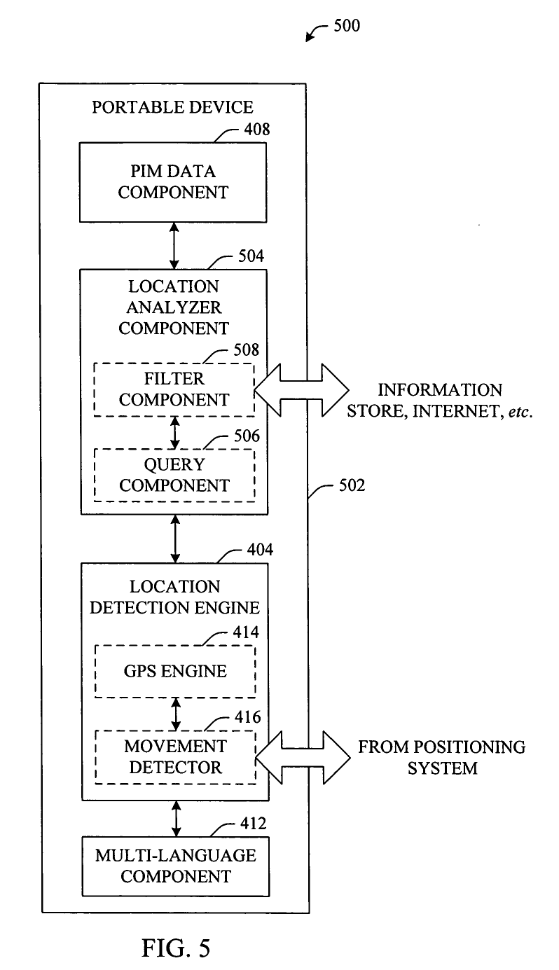

FIG. 5 illustrates an alternative system 500 in accordance with an aspect of the invention. Generally, system 500 includes a portable device 502 that can communicate with a positioning system and provide location-based data and/or services in accordance therewith. Portable device 502 can be any portable computing device including, but not limited to a cellular telephone, PDA, pocket computer, smartphone or the like. The portable device 502 can include a location detection engine 404 and a location analyzer component 504.

As described supra, the location detection engine 404 can include a GPS engine 414 and a movement detector 416 integrated therein. The location analyzer component 504 can include a query component 506 and a filter component 508. In operation, the location analyzer component 504 can employ the query component 506 to access location-based information from PIM data component 408, a remote information store and/or network (e.g., Internet). Further, the filter component 508 can be employed to limit (e.g., filter) the queried data based at least in part upon the location identified by the GPS engine 414 or the location augmented by the movement detector 416.

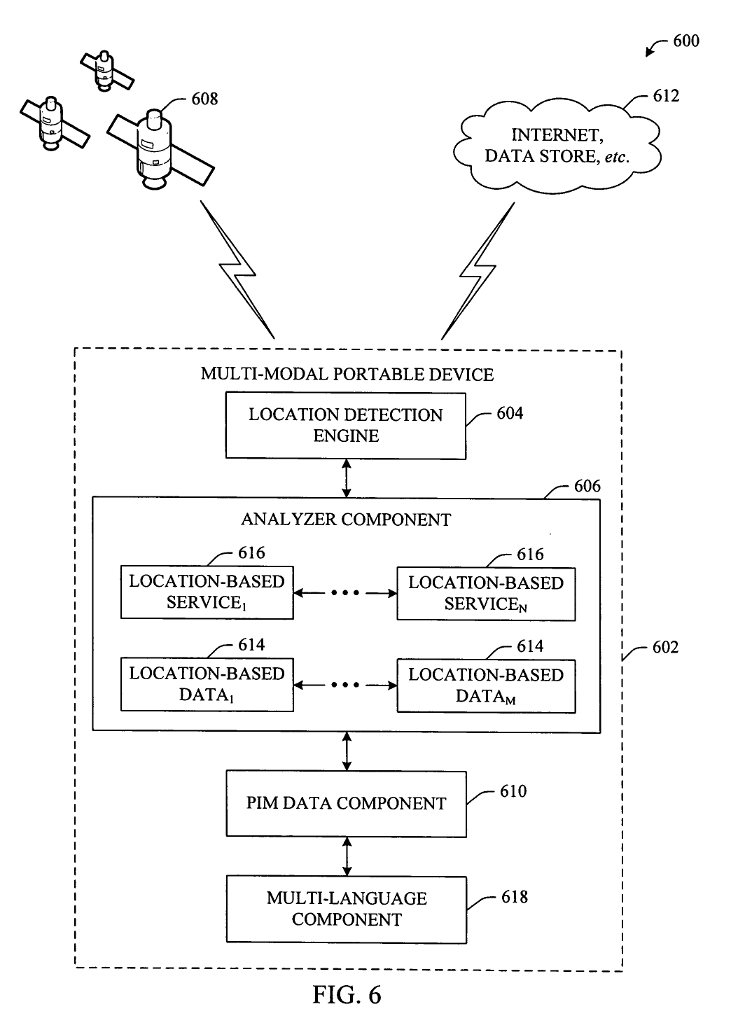

With reference now to FIG. 6, a system 600 that facilitates providing multi-modal based services is provided. System 600 can include a multi-modal device 602 having a location detection engine 604 and an analyzer component 606. The location detection engine 604 can determine a location of the device 602 using signals received from a satellite, a group of satellites 608 (e.g., GPS), or provided by a local system employed by a business or organization (e.g., a department store may provide signals that allow the device to identify the user's position inside the store). Additionally, it is to be understood that the location detection engine 604 can additionally employ a movement detection component (not shown) to augment location identification. Accordingly, a target location can be inferred enabling the portable device 602, via analyzer component 606 to provide location-based information (e.g., data, services, etc.).

More particularly, analyzer component 606 can query PIM data 610 based upon current and/or target location information. As well, the analyzer component can access a remote data store and/or network (e.g., Internet) 612 to obtain and generate location-based information. As illustrated, analyzer component 606 can generate location-based data components 1 to M, where M is an integer. As shown, location-based data components 1 to M can be referred to individually or collectively as location-based data components 614. Location-based data components 614 can include, but are not limited to, location-based truncated contact lists, location-based restaurant listings and corresponding promotional coupons, location-based companies, location-based shopping information, including current sales and promotions, etc.

Similarly, analyzer component 606 can identify 1 to N location-based service components, were N is an integer. It is to be appreciated that 1 to N location-based service components can be referred to individually or collectively as location-based service components 616. By way of example, but not limitation, location-based service components 616 can include location-based suggestions (e.g., stop at grocery), location-based reminders (e.g., pick up dry cleaning), location-based alerts (e.g., traffic conditions), etc.

A multi-language component 618 can be provided to further enhance the generation and utilization of location-based data 614 and location-based service 616. For example, the multi-language component 618 can render textual data and/or services in a language or dialect consistent with a present location of the device 602. Additionally, multi-language component 618 can produce comprehending voice commands delivered in a language based upon the present location of the device 602. Moreover, the multi-language component 618 can involve rendering the location-based data 614 and/or the location-based services 616 audibly consistent with a device location-based language.

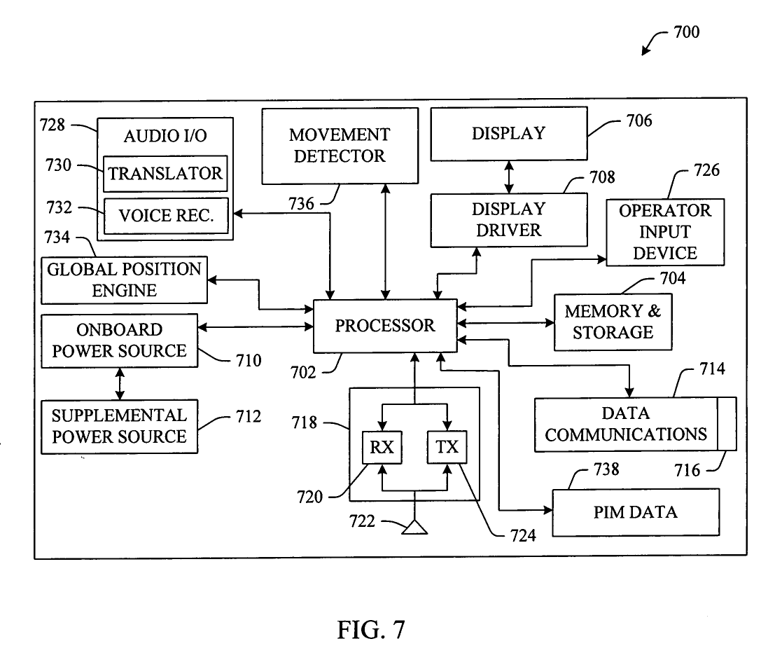

Referring now to FIG. 7, there is illustrated a schematic block diagram of a portable hand-held device 700 according to one aspect of the subject invention, in which a processor 702 is responsible for controlling the general operation of the device 700. The processor 702 can be programmed to control and operate the various components within the device 700 in order to carry out the various functions described herein. The processor 702 can be any of a plurality of suitable processors (e.g., a DSP-digital signal processor). The manner in which the processor 702 can be programmed to carry out the functions relating to the subject invention will be readily apparent to those having ordinary skill in the art based upon the description provided herein.

A memory and storage component 704 connected to the processor 702 serves to store program code executed by the processor 702, and also serves as a storage means for storing information such as current locations, inferred target locations, user states, location-based data, location-based services or the like. The memory and storage component 704 can be a non-volatile memory suitably adapted to store at least a complete set of the information that is acquired. Thus, the memory 704 can include a RAM or flash memory for high-speed access by the processor 702 and/or a mass storage memory, e.g., a micro drive capable of storing gigabytes of data that comprises text, images, audio, and video content. According to one aspect, the memory 704 has sufficient storage capacity to store multiple sets of information, and the processor 702 could include a program for alternating or cycling between various sets of display information.

A display 706 is coupled to the processor 702 via a display driver system 708. The display 706 can be a color liquid crystal display (LCD), plasma display, touch screen display, or the like. In one example, the display 706 is a touch screen display. The display 706 functions to present data, graphics, or other information content. Additionally, the display 706 can display a variety of functions that are user selectable and that control the execution of the device 700. For example, in a touch screen example, the display 706 can display touch selection icons that facilitate user interaction for control and/or configuration.

Power can be provided to the processor 702 and other components forming the hand-held device 700 by an onboard power system 710 (e.g., a battery pack or fuel cell). In the event that the power system 710 fails or becomes disconnected from the device 700, a supplemental power source 712 can be employed to provide power to the processor 702 (and other components (e.g., sensors, image capture device, . . . )) and to charge the onboard power system 710, if a chargeable technology. For example, the alternative power source 712 can facilitate an interface to an external grid connection via a power converter. The processor 702 of the device 700 can induce a sleep mode to reduce the current draw upon detection of an anticipated power failure.

The device 700 includes a communication subsystem 714 that includes a data communication port 716, which is employed to interface the processor 702 with a remote computer, server, service, or the like. The port 716 can include at least one of Universal Serial Bus (USB) and/or IEEE 1394 serial communications capabilities. Other technologies that can also be employed are, but are not limited to, for example, infrared communication utilizing an infrared data port, Bluetooth™, Wi-Fi, Wi-Max, etc.

The device 700 can also include a radio frequency (RF) transceiver section 718 in operative communication with the processor 702. The RF section 718 includes an RF receiver 720, which receives RF signals from a remote device via an antenna 722 and can demodulate the signal to obtain digital information modulated therein. The RF section 718 also includes an RF transmitter 724 for transmitting information (e.g., data, services) to a remote device, for example, in response to manual user input via a user input (e.g., a keypad, voice activation) 726, or automatically in response to the completion of a location determination or other predetermined and programmed criteria.

The transceiver section 718 facilitates communication with a transponder system, for example, either passive or active, that is in use with location-based data and/or service provider components. The processor 702 signals (or pulses) the remote transponder system via the transceiver 718, and detects the return signal in order to read the contents of the detected information. In one implementation, the RF section 718 further facilitates telephone communications using the device 700. In furtherance thereof, an audio I/O subsystem 728 is provided and controlled by the processor 702 to process voice input from a microphone (or similar audio input device). The audio I/O subsystem 728 and audio output signals (from a speaker or similar audio output device). A translator 730 can further be provided to enable multi-lingual functionality of the device 700.

In another implementation, the device 700 can provide speech recognition 732 capabilities such that when the device 700 is used as a voice activated device, the processor 702 can facilitate high-speed conversion of the voice signals into text or operative commands. For example, the converted voice signals can be used to control the device 700 in lieu of using manual entry via the keypad.

Other devices such as a location detection engine 734 and/or a movement detector 736 can be provided within the housing of the device 700 to affect functionality described supra. For example, the location detection engine 734 can be provided to affect the analyzer component (e.g., processor 702) to identify and/or provide location-based data and/or services. In another example, the movement detector 736 can augment the information provided by the location detection engine 724 which further facilitates the analyzer component (e.g., processor 702) to infer or predict a target location of the device 700.

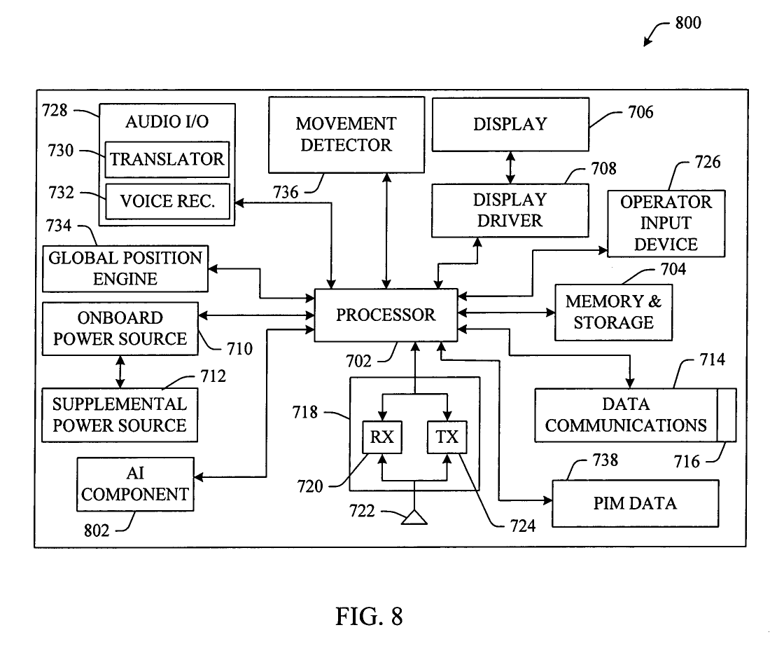

FIG. 8 illustrates a system 800 that employs artificial intelligence (AI) component 802 which facilitates automating one or more features in accordance with the subject invention. The subject invention (e.g., with respect to determining a present or target location, communicating location-based data and/or services . . . ) can employ various AI-based schemes for carrying out various aspects thereof. For example, a process for determining or inferring a target location or for determining a location-based service (or data) can be facilitated via an automatic classifier system and process.

A classifier is a function that maps an input attribute vector, x=(x1, x2, x3, x4, xn), to a class label class(x). A classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs that splits in an optimal way the triggering input events from the non-triggering events. Other classification approaches, including Naïve Bayes, Bayesian networks, decision trees, neural networks, fuzzy logic models, maximum entropy models, etc., can be employed. Classification as used herein also is inclusive of statistical regression that is utilized to develop models of priority.

As will be readily appreciated from the subject specification, the subject invention can employ classifiers that are pre-trained (e.g., via a generic training data from multiple users) as well as methods of reinforcement learning (e.g., via observing user behavior, observing trends, receiving extrinsic information). Thus, the subject invention can be used to automatically learn and perform a number of functions, including but not limited to determining, according to a predetermined criteria, a present and/or target location, location-based data and/or services, when/if to communicate data location-based services, which language and/or translation to employ, etc.

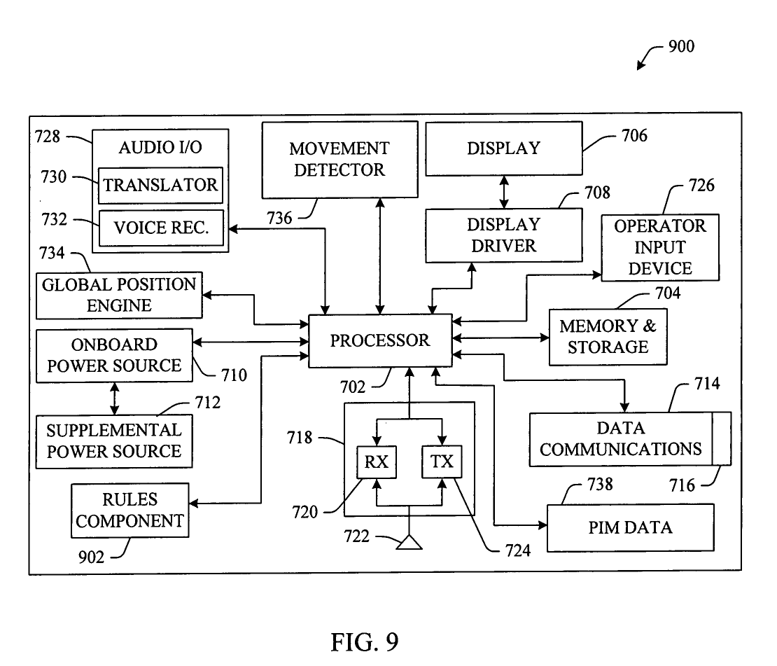

With reference now to FIG. 9, an alternate aspect of the invention is shown. More particularly, handheld device 900 generally includes a rules-based logic component 902. In accordance with this alternate aspect, an implementation scheme (e.g., rule) can be applied to define thresholds, initiate location detection, facilitate communication of location-based services, etc. By way of example, it will be appreciated that the rule-based implementation of FIG. 9 can automatically define criteria thresholds whereby an analyzer component or processor 902 can employ the thresholds to determine a location-based service and/or set of data.

In response thereto, the rule-based implementation can affect determination of location-based data and/or services by employing a predefined and/or programmed rule(s) based upon any desired criteria (e.g., distance). For example, a rule can be employed that determines a geographical area that surrounds a current location. In accordance therewith, the rule can be employed to truncate PIM contacts or calendar entries that do not apply within the defined geographical area. In another example, the distance threshold can be employed to define a particular business within the defined geographical area. This can be particularly useful to a patron or salesperson that seeks to visit a particular business type.

It is to be appreciated that any of the specifications and/or functionality utilized in accordance with the subject invention can be programmed into a rule-based implementation scheme. It is also to be appreciated that this rules-based logic can be employed in addition to, or in place of, the AI reasoning components described with reference to FIG. 8.

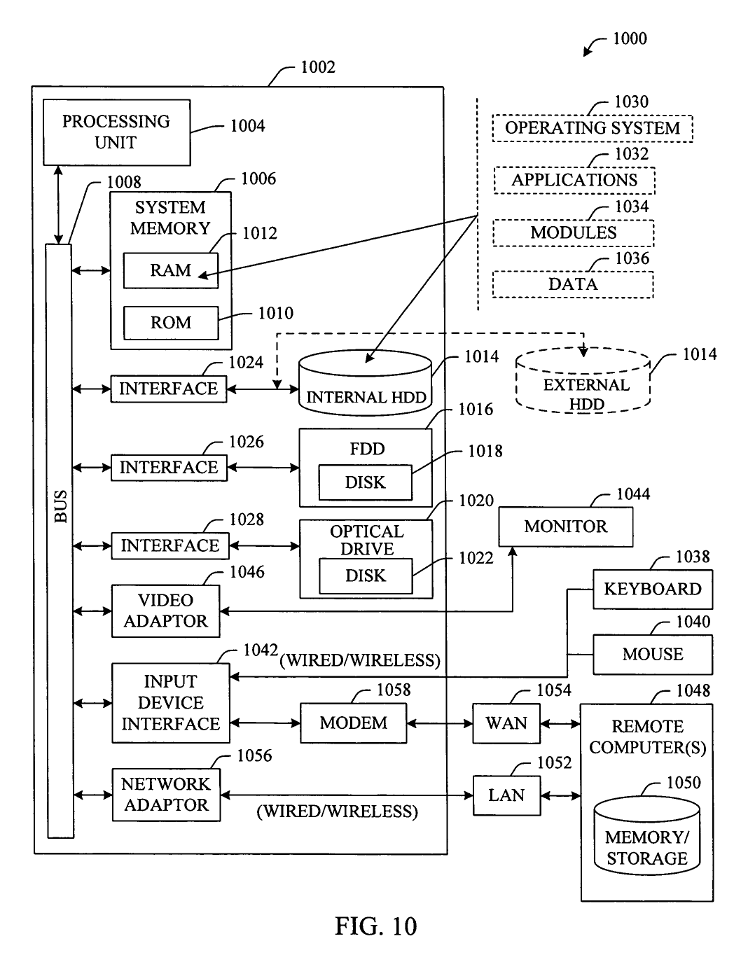

The aforementioned functionality can be employed within any computing device including, but not limited to, a cellular telephone, smartphone, pocket computer, laptop computer, PDA or the like. Referring now to FIG. 10, there is illustrated a block diagram of a computer operable to execute the disclosed architecture. In order to provide additional context for various aspects of the subject invention, FIG. 10 and the following discussion are intended to provide a brief, general description of a suitable computing environment 1000 in which the various aspects of the invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the invention includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the invention can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cellular telephone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

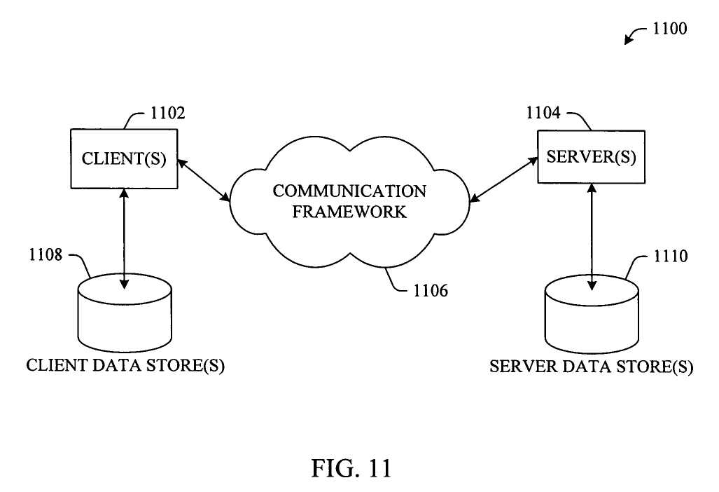

Referring now to FIG. 11, there is illustrated a schematic block diagram of an exemplary computing environment 1100 in accordance with the subject invention. As illustrated in FIG. 11, it is to be understood that the “client(s)” can be representative of a portable device and the “server(s)” can be representative of a host computer or other disparate portable device. As shown, the system 1100 includes one or more client(s) 1102. The client(s) 1102 can be hardware and/or software (e.g., threads, processes, computing devices). The client(s) 1102 can house cookie(s) and/or associated contextual information by employing the invention, for example.

The system 1100 also includes one or more server(s) 1104. The server(s) 1104 can also be hardware and/or software (e.g., threads, processes, computing devices). The servers 1104 can house threads to perform transformations by employing the invention, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the invention. It is, of course, not possible to describe every conceivable combination of components or methodologies for purposes of describing the subject invention, but one of ordinary skill in the art may recognize that many further combinations and permutations of the invention are possible. Accordingly, the invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-language system that facilitates providing location-based information, comprising:
a location context component that provides content based at least in part upon a location of a portable device; and
a multi-language component that converts the content into a language comprehendible by a user of the portable device.

2. The multi-language system of claim 1, the location context component comprises:
a location detection engine that determines the location of the portable device; and
a location analyzer component that determines the content based at least in part upon the location, the content includes at least one service.

3. The multi-language system of claim 2, further comprising a personal information manager (PIM) component, the location analyzer component queries the PIM component based at least in part upon the location and determines location-based data.

4. The multi-language system of claim 2, the location detection component comprises a positioning engine and a movement detector.

5. The multi-language system of claim 4, the movement detector is at least one of an accelerometer, a compass, an azimuth control and a cellular triangulation component.

6. The multi-language system of claim 2, the service is at least one of providing location-based data, providing a location-based suggestion, providing a location-based reminder, providing a set of location-based directions, providing a location-based traffic alert, providing a location-based weather forecast and providing a route suggestion based at least in part upon one of a task pre-loaded in a PIM and the location-based suggestion.

7. The multi-language system of claim 6, the location-based data is filtered PIM data based at least in part upon the location.

8. The multi-language system of claim 2, further comprising a portable communications device that comprises the location detection engine and the location analyzer component.

9. The multi-language system of claim 1, further comprising an artificial intelligence (AI) component that infers a target location, the location context component provides additional content based at least in part upon the target location.

10. The multi-language system of claim 1, further comprising a rules-based logic component that facilitates automatic implementation of an action based at least in part upon a rule.

11. A computer-readable medium having stored thereon computer-executable instructions for carrying out the multi-language system of claim 1.

12. A computer-implemented method of communicating location-based information, comprising:
determining a location of a portable device;
querying electronic information based at least in part upon the location;
establishing a service based at least in part upon a result of the act of querying electronic information;
formatting the service in a language comprehendible to a user; and
communicating the formatted service to the user.

13. The computer-implemented method of claim 12, further comprising detecting a movement direction of the portable device and incorporating the movement direction into the act of querying electronic information.

14. The computer-implemented method of claim 13, the electronic information is PIM data maintained in the portable device.

15. The computer-implemented method of claim 13, the electronic information is maintained in a remote data store.

16. The computer-implemented method of claim 13, further comprising filtering the electronic information based at least in part upon the location.

17. The computer-implemented method of claim 12, the act of generating the service further comprises inferring a movement of the portable device based at least in part upon one of a historical and a statistical criterion.

18. The computer-implemented method of claim 12, the act of establishing the service further comprises applying a rule that defines a user criterion.

19. A multi-modal, multi-lingual mobile device that facilitates generation of a location-based service, comprising:
means for determining a current location of the multi-modal, multi-lingual mobile device;
means for inferring a target location of the multi-modal, multi-lingual mobile device based at least in part upon the current location of the multi-modal, multi-lingual mobile device;
means for analyzing data based at least in part upon the inferred target location;
means for augmenting a service based at least in part upon an output of the act of analyzing data; and
means for communicating the augmented service in a language comprehendible by the user.

20. The multi-modal, multi-lingual mobile device of claim 19, comprising means for augmenting the current location with at least one of a compass, an accelerometer, an azimuth control and a cellular triangulation.
